(19) United States
(12) Patent Application Publication
(10) Pub. No.: US 2005/0134427 A1
(43) Pub. Date: Jun. 23, 2005

(54) Technique using order and timing for enhancing fingerprint authentication system effectiveness

(76) Inventor: Christopher David Hekimian, Germantown, MD (US)

Correspondence Address: CHRISTOPHER DAVID HEKIMIAN, 13416 RISING SUN LANE, GERMANTOWN, MD, 20874, US

(21) Appl. No.: 10/741,087

(22) Filed: Dec. 20, 2003

(51) Int. Cl. H04Q 1/00; G05B 19/00

(52) U.S. Cl. 340/5.53

(57) ABSTRACT

The invention, which is an embodiment of what the inventor calls, “Active behavior Fingerprint Authentication” is one which employs a sequential reading of fingerprints of various fingers, in a way that may or may not be time constrained, as a means to improve authentication security. Authentication security is strengthened based upon the reduced likelihood that a potential intruder would 1.) Know what the correct sequence of fingerprints were associated with the control authentication template; 2.) Know the correct timing characteristics associated with successive fingerprint readings; 3.) Be able to successfully “hack” the authentication server in order to gain access to minutia or image information, and finger sequence information, and timing information, which would be required in order to fully compromise the authentication system. The technique embodied by the invention represents an overlay of a known, ordered sequence, which may or may not be timed, over the fingerprint authentication process itself.

### PATENT REFERENCES CITED

U.S. Pat. No. 6,476,797, Nov. 5, 2002, Kurihara et al

No federally funded research was associated with the development of this invention.

### BACKGROUND OF THE INVENTION

1. Field of the Invention

The invention is a means of computer program or system access or facilities access control by means of authentication through identity verification. The new system constitutes an important improvement over traditional fingerprint authentication and access control methods.

Fingerprint authentication methods can be used for controlling access to individual computer programs or databases, to networks and network based assets, or as a means of controlling access to fixed facilities or vehicles. The security afforded by the invention represents an improvement over the security available from conventional fingerprint reading approaches and has the potential to dramatically reduce the risk posed by a penetrated network or faked fingerprint.

The new invention lends itself to any purpose that is currently served by a fingerprint reading authentication system, or other biometric security system.

2. Prior Art

Fingerprint-based authentication systems are based upon one of two basic processing technologies, these are image matching technology and minutiae logging systems [1]. The term “minutiae” as it applies to fingerprints refers to the “ . . . locations on your fingerprint where the ridges will stop or split into two, or intersect.(ridge ends and bifurcations)” [2]. In practice, subject identification is positively achieved by comparing a digitally stored image, or log of minutia, obtained at the point of access, to a known set stored on an authentication server.

The two main sensing schemes associated with fingerprint recognition systems are optical scanning and capacitive scanning. Capacitive scanning offers the least vulnerable solution because it can be made to only respond to skin and can be made to better distinguish between actual and simulated fingerprints [3]. Both optical and capacitive scanning technologies are subject to reduced reliability due to sensor wear or accumulated dirt and/or grime.

Fingerprint based authentication techniques have been in use in facilities access control for as long as supporting technologies such as digital computers, have been available. The fact that a fingerprint, in theory, allows for definite one to one identity verification have made fingerprint systems the identification and access control method of choice for high security applications. As other technologies continued to advance, including the ability to acquire and copy fingerprints, and “resist” methods to make duplicate fingerprints, risk management in the form of new ways to guard against faked fingerprints has been the subject of considerable interest.

Currently, attacks on fingerprint authentication systems have been in the following forms;
1. Prosthetic attack, where a fingerprint of an authorized person is obtained and is duplicated using a computerized imaging tools, and a printable resist method. The faked fingertip is worn and used to gain access to the protected system or facilities.
2. Server attacks, where the computer hosting the authentication server is attacked so as to compromise the authentication registry associated with fingerprint images or logs of minutia. Fraudulent images or logs of minutia are substituted so subsequent authentication transactions will allow the intruder in as a phantom user, or in place of a formerly authorized user.
3. Replay attacks, where a “man in the middle” monitors a data line and captures a successful authentication transaction that is replayed to the authentication server at a later time in order to gain unauthorized access.

In order to meet the challenges imposed by the hostile measures listed above, existing fingerprint authentication techniques have been enhanced to sense the capacitance of the human skin during the reading process or to look for other factors of “liveness” such as body warmth or detected pulse. Anti-penetration tools, firewalls and secure protocols are used to best secure the authentication servers.

The new invention adds up to 3 additional layers of security against the prosthetic attacks enumerated above. An intruder seeking to gain unauthorized access would need to not only have multiple prosthetic sets of fingerprints, he/she would need to know in which order they need to be submitted. Furthermore, for time domain sensitive implementations, an intruder would need to apply the ordered fingerprints in relation to a time profile sufficiently close to the one established by the authorized user whose account is under attack. For systems employing a plurality of fingertip sensors, the attacker would still yet be required to know which sensors were used for which fingers.

With respect to the server attack scenario listed above, the new invention can also supply 3 additional layers of security. With the new technique, an offline attacker would not only need to capture and or compromise the authentication server-maintained fingerprint registry, the attacker would also be required to capture a registry defining the order of the fingerprints, a registry defining the time element associated with the sequence of ordered fingerprints, and a registry defining which of a plurality of sensors were used to enter the multiple fingerprint authentication sequence. The new technique does not by itself offer significant security against replay attacks. Measures such as that described in U.S. Pat. No. 6,549,118 by Seal, et al, could be applied to this purpose.

No prior art has been found that employed either a multiple fingerprint process; a process that involved the ordering of successive fingerprints as a basis for authentication; a fingerprint authentication process which relied on time elements to further restrict authentication, or one which used a plurality of fingerprint scanning sensors as a means to restrict the authentication process. The following patent is included as a reference not because it is similar to the new system per se, but because some of the language in the claims tend to overlap in a manner that might make the to methods seem more similar than they are in fact.

The search of related patents revealed one, U.S. Pat. No. 6,476,797 by Kurihara, et al. Kurihara, et al, teaches two alternate methods of authentication using touch sensitive display technology [Kurihara, claim 1] One involves the ordered touching of a plurality of touch switch regions [Kurihara claims 8, 9]. The other method involves the touching of one touch switch that can perform a fingerprint scan [Kurihara claims 11, 13]. Kurihara does not teach an ordered or timed and ordered fingerprint authentication method that can be used without a touch screen display, therefore precluding its use with basic and low cost fingerprint scanning technologies. Claim 11 of Kurihara's teaching indicates that the “touch switch region” is provided with “an image read function” which, when taken with the description of “a fingerprint authentication switch”, item 2 in the detailed description of the invention, indicates that the Kurihara method does not involve the analysis of a sequence of fingerprints for authentication purposes. The description that Kurihara provides in support of FIG. 2A indicates that ordering associated with the Kurihara method, involves the ordering of touches to a “plurality of touch switch regions” [Kurihara, Claim 8] on a display area. The touch switch regions provide a functionality similar to a combination lock made up of an array of single throw toggle switches.

In order to summarize the relationship between Kurihara's invention and the new invention, the new invention can be implemented in a manner that is sensitive to finger order; finger and sensor order; timing and sensor order; timing and finger order; timing and finger and sensor order. Kurihara's method involves one touch screen display which can facilitate a sensor order authentication function (i.e. touch switches), and a functionally independent single fingerprint authentication process (one touch switch region that can perform a fingerprint scan).

### SUMMARY OF THE INVENTION

The new system adds the elements of finger order and time sensitivity to the existing fingerprint-based authentication process. It is also possible to omit either of the factors above such that the system relies only on finger order or only on time sensitivity. It is also possible to increase the number of theoretically possible authentication sequences by increasing the number of fingerprint sensors. To do so would affect the number of potential authentication sequences exponentially, and provide the same effect as turning a one-handed system into a two-handed one.

The new invention, is unique, being different than all existing fingerprint based authentication techniques due to the distinguishing characteristics of;
1. Requirement of multiple fingerprint sensing procedures for each authentication process
2. Requirement that the multiple sensing processes can be made up of data supplied by different fingers.
3. Ability to require that multiple sensing processes conform to a predetermined time profile.
4. Requirement that the authentication server maintain registries of fingerprint data and finger order data.
5. Requirement that the authentication server maintain registries of fingerprint data and time profile data.
6. For cases where multiple sensors might be used, a requirement can be imposed that the authentication server maintain registries of fingerprint data and sensor identification data.

Using our prototype, single sensor system and the simple example of a four finger reading of a time independent authentication sequence involving the fingers of only one hand, an impostor armed with a simulated fingerprint would have over 1000 (4⁵=1024) choices from which to select the correct fingertip order in order to gain access. It is typical to block access to a secured asset after 3 unsuccessful attempts. For authentication sequences involving additional readings, the number of potentially valid authentication sequences increases exponentially. For a time sensitive implementation of the technique that we proposed, if we were to allow for a four fingertip sequence to be carried out over the course of at least 15 seconds, and the 15 second authentication period was divided up into 250 ms intervals, the set of theoretically possible authentication sequences is increased to approximately 500 million. Therefore, even if a full set of fake fingerprints were available to an intruder, the odds of it being used effectively to penetrate a system protected by our invention would be astronomical.

The inventor maintains that the current invention represents an important and original contribution to computer security authentication methods.

### DETAILED DESCRIPTION

The active behavior enhanced fingerprint authentication system can be implemented in a manner that is sensitive to finger and/or sensor order and timing or sensitive to finger and sensor order only, or sensitive only to finger order. For the sake of generality, a system based upon finger order and timing will serve as the basis of our description. While many variations exist with respect to how the new method could be implemented, we present only one recommended approach here. For the sake of simplicity, we assume the case where only one sensor is used. The case where more than one sensor is can be analyzed based upon a simple extension of the discussion presented here.

The active behavior enhanced fingerprint authentication system can be implemented with existing fingerprint reading hardware and with relatively minor modifications to existing software. Time sensitive instantiations of the new method will require that an electronic timer be incorporated into the sensing apparatus. Fingerprint sensing apparatuses are often peripheral to a personal size computer. Such configurations would not require any hardware changes in order to achieve the full functionality of the new method. The methods described for fingerprint sensing and timing data collection, storage, communication and authentication decision making can each be performed readily and effectively based upon a number of different algorithms that could be implemented by a skilled computer programmer in a host of different computer languages and language configurations.

The general active behavior enhanced fingerprint authentication system can be carried out using fingerprint sensing stations that differ from existing stations at most by the incorporation of an electronic timer, and a means to provide the timer count to the authentication server along with the sensed fingerprint data. Incorporation of such features would be a task realizable by anyone skilled in the art of electronic circuit design and would be likely be considered trivial by a designer of existing fingertip scanning devices.

Setting up the Authentication Profile

Similar to how a password system must establish what the valid password to be associated with a user's account is, the time sensitive and finger order and sensor order components of the new technique must be established with the authentication server before each individual uses the system. The fingerprint data can be collected implicitly with the timed ordering process. An example of how the timed and ordered authentication profile generation process could begin as follows:

The timer or “clock” begins counting in fixed increments of perhaps a quarter of a second, from the time of detection of the first closure of fingertip to fingertip sensing pad. At each subsequent fingertip closure, the fingerprint data is stored in a FIFO buffer local to the sensing station, with the count of the timer appended as a header. For the case where a multiple sensing pad configuration is used, the header information would be appended with an identifying code which would allow the authentication server to know which sensing pad was used for the fingertip scan data. The authentication server could maintain the sensor identification data with the timing data, or could maintain a separate registry for the data, further increasing the security of the information.

Following the last fingerprint scan, the pressing of an “Enter” or “Send” button (at the appropriate time for timed sequences) would terminate the authentication sequence and initiate the sending process by which the authentication sequence, made up of concatenated fingerprint data, with timing and order data, if applicable, is transmitted to the authentication server. The use of a send command allows for authentication sequences involving different numbers of fingers to be used, allows for the authentication sequence to be transmitted to the authentication server all at once, and allows for one more time parameter to be associated for authentication sequences involving the same number of fingers. The extra time parameter increases the size of the set of the possible number of timed ordered sequences dramatically. For the 4 finger, 15 second, 250 ms bin example that was described on pages 5 and 6, the use of an enter command increases the size of the authentication space from a theoretical 3.5 million sequences to about 500 million. The send command could be implemented entirely by software by having the sensing station sensor respond to finger taps. After the data from successive fingerprint scans and the associated time intervals between closures have been collected, the user is prompted to repeat the proposed authentication sequence.

During the typical confirmation process, the fingerprint image data should conform completely to those maintained in the server for the 1^{st}, 2^{nd}, 3^{rd}, . . . etc. fingerprints that are part of the authentication sequence. Furthermore, the intervals between fingertip closures must correlate to the ones established in the in time key vector within a degree which can be made variable, based upon convenience and the level of supplemental security desired. If the authentication server determines that the confirmation sequence of fingerprint data and time key vector match the initial sequence of fingerprint data and time key vector (within dictated bounds) then the server system accepts both the initial fingerprint order and associated time key vector as the control template for the active behavior enhanced fingerprint authentication system. A successful authentication profile set-up process or authentication transaction can be signaled by means of a simple, audible tone and/or visual indicator. Similarly, unsuccessful transactions can be signaled with a different tone and/or visual indicator.

The time sensitive active behavior fingerprint authentication system control template for each user can be entered into a fingerprint sensing station in rhythm to a song that the user is familiar with. Like notes played on a piano, different fingers could be used in the specified order. In effect, the new technique imparts a means of time gating or “windowing” where only fingerprint data that are entered within the time periods established based upon the expected time key vector can contribute to a successful authentication transaction. Fingerprint data occurring outside of the expected windows would contribute to the rejection of the authentication request.

Carrying out an Authentication Transaction on the Sensing Station Side

An example of how the authentication process associated with the new technique would work in practice follows the same basic process as that of setting up the authentication profile. The new authentication process can be viewed as a timed sequence of conventional fingerprint authentication transactions, terminated by an Enter command. Therefore, multiple sets of fingerprint data form the basis for each authentication transaction, and the order of the data and the time elapsed between them, is critical to the authentication decision.

Various methods for encrypting the authentication data can be used, including techniques that allow for a change in encryption key for each successive, successful authentication transaction. These so-called “one-time” encryption techniques which are based upon evolving keys are particularly effective in defending against “man in the middle” attacks.

Carrying out Authentication on the Server Side

The recommended implementation for the server side of the authentication transaction begins with the receipt of the complete authentication sequence, in packet form, from the scanning station. The authentication server strips off the first set of fingerprint data and attempts to find a match for it among all of the fingerprint data that it maintains in its fingerprint authentication registry. If a match is found, the remaining fingerprint data is checked against the fingerprint data contained in the indicated control template. Should a one-to-one correspondence exist, further distinction among potential authentication candidates can be made by computing an error term made up, for example, of the square root of the sum of the squared errors between the time key vector provided by the authentication candidate and the one that is maintained in the control template. If the error is sufficiently low, authentication is considered to be achieved and access is granted. It may be desirable to compute an error term based upon the time elapsed between successive fingertip closures as opposed to the absolute count of the clock. To take the latter approach removes the tendency for error to accumulate such that later timing data is independent from error imparted on previous finger scans.

### BRIEF DESCRIPTION OF THE DRAWINGS

FIG. 1 depicts a multiplicity of fingerprint sensing stations [FIG. 1, 1], each equipped with one fingerprint sensing pad. In practice, said fingerprint sensing stations would be connected via a data network or other medium [FIG. 1, 2], which could be wireless, to an authentication server [FIG. 1, 3]. Fingerprint sensing stations may or may not be configured as personal type computers with one or more fingerprint sensing pads as a peripheral input device. For cases where they are not configured peripherally with personal type computers, the fingerprint sensing stations must be equipped with a timing function, temporary data storage capacity, and the ability to communicate with the authentication server.

FIG. 2 depicts a possible implementation of a fingerprint sensing station. The example consists of a sensing station case [FIG. 2, 1] which is shown with the capacity to connect directly to a wired network [FIG. 2, 6], and to receive power [FIG. 2, 7]. The example is of a two sensor pad configuration which, as such, would require the party seeking authentication to not only authenticate with the correct fingers in the correct order, but would also require that the correct pad be used for each finger scan. The two sensor sensing pad shown [FIG. 2, 2] has a “ready” indicator light [FIG. 2, 3] and an ENTER, or send command pushbutton [FIG. 2, 4]. The “ready” indicator demonstrates that the sensing station is in service and ready to conduct an authentication transaction. The ENTER pushbutton is used to terminate the fingerprinting sequence, whether timed or not, and initiates the data transfer through the data medium, to the authentication server. For timed authentication sequences, the recommended method would include the clock count associated with the closure of the ENTER key with the authentication packet. It is possible to implement the send function without the use of a separate ENTER pushbutton. Using software, sensing pads can be made to distinguish a quick finger tap from the longer finger press that is required for imaging.

The sensing station is shown with a speaker for audible tones [FIG. 2, 5]. The speaker is recommended so that successful or unsuccessful authentication transactions are quickly identified. Sensing stations peripheral to personal type computers already have audio capabilities available.

FIG. 3 is a diagram showing an example of a basic authentication process flow as handled by a sensing station and the authentication server. The element of time progresses as one moves down and/or across the chart. Consistent with the recommended method, the example shows that the authentication process begins on the sensing station side with the closure of a finger tip on a sensing pad.

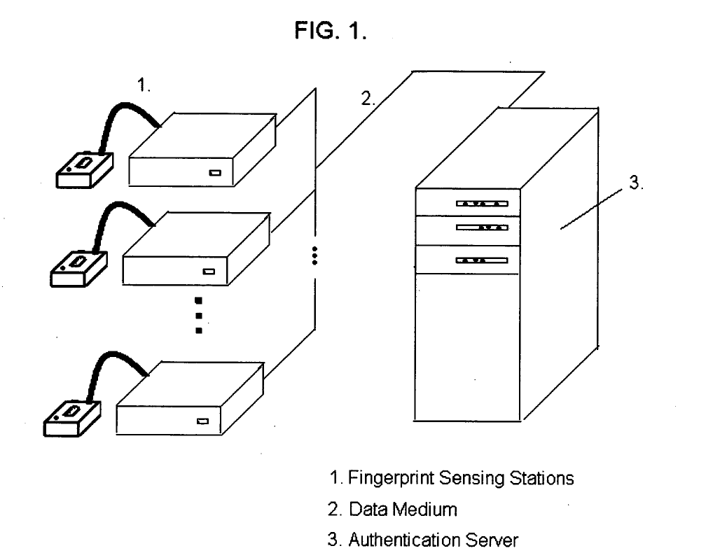

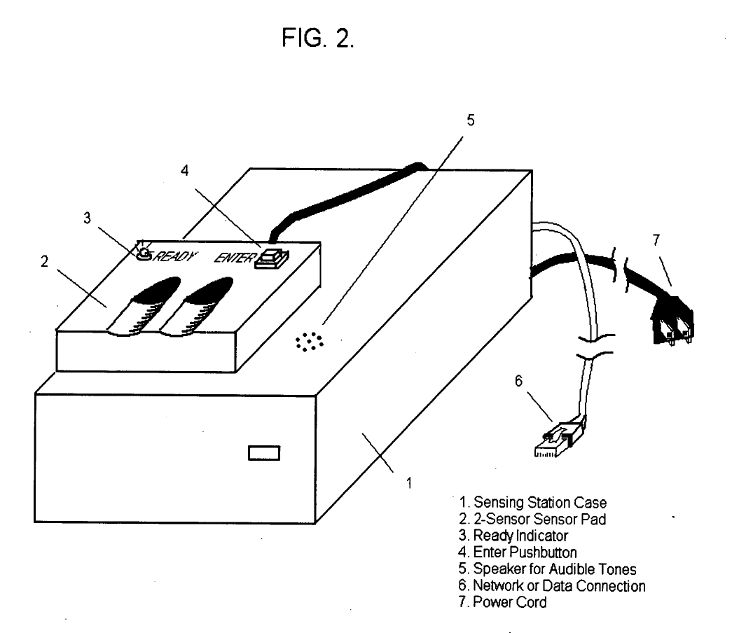

A clock local to the sensing station counts in fixed increments starting from this first fingertip closure. The fingertip is pressed on the sensing pad for a time sufficient for imaging to take place. Then the image data is stored to a FIFO data buffer local to the sensing station. Upon the lifting of the first fingertip and the closure of the next one, the sensing station stores the new clock count and scans the new fingertip. Concurrent with all successive fingertip scannings the sensing station is able to detect send commands. The send command terminates the scanning process and initiates the data transmission process. With each cycle of fingertip lifting and closure, until the send command is detected, the clock count is saved to the buffer as header to the fingerprint data. When the send command is introduced, transmission of the sensing stations local FIFO buffer contents is made to the authentication server (which has been inactive with respect to this authentication transaction up to this point in time). The first bit of data appearing in the authentication packet is of the first fingerprint provided by the party seeking authentication. It is stripped off the data packet and used as a key to carry out the first stage of the user identification process. Using the first fingerprint, the entire set of control fingerprint data, is identifiable if the authentication transaction is done correctly by an authorized user. If a match is not found, authentication fails and access is not granted. A message is returned to the sensing station seeking authentication that access is denied. Should a match between the first candidate fingerprint and a fingerprint for a valid user in the fingerprint registry be found, and the server verifies that the account in question is not “blocked”, a cycle by which timing data, with sensing pad identification data if applicable, and fingerprint data are sequentially stripped off of the received data packet is performed by the authentication server. The timing data is used to form a candidate time key vector and a sensing pad identification data is used to form a candidate sensing pad identification sequence, if applicable. Subsequent to the processing of the candidate authentication packet described above, the fingerprint data, other than the first fingerprint, which has already been checked, is checked, in order against the ordered fingerprint data in the control set of fingerprint data. If any of the corresponding pairs do not match, authentication fails and access is not granted. A count of unsuccessful authentication attempts on the account identified by the first candidate (key) fingerprint is incremented. A message is returned to the sensing station seeking authentication that access is denied. Should the maximum number of consecutive unsuccessful authentication attempts be exceeded, the account in question is blocked.

If the candidate and control fingerprint data could be matched, and the authentication sequence is a time domain sensitive one, an error term relating the difference between the timing characteristics of the candidate and control authentication sequences is calculated. Should the error be sufficiently small, authentication is deemed successful, access is granted and a message is conveyed to the sensing station to signal a successful authentication. Should the error be too high, authentication fails and access is not granted. A count of unsuccessful authentication attempts on the account identified by the first candidate (key) fingerprint is incremented. A message is returned to the sensing station seeking authentication that access is denied. Should the maximum number of consecutive unsuccessful authentication attempts be exceeded, the account in question is blocked.

FIG. 4 is intended to clarify the nature of the authentication sequence associated with a user by means of an example. FIG. 4, 1 shows how the five fingers of a persons hand might be distinctly identified. FIG. 4, 2 shows a possible ordering of 4 fingers of a person's hand that could be used as a basis for our new authentication system. Should the authentication process be time domain sensitive, the time intervals between successive fingerprint scanning processes, or the relative locations in time, for each fingerprint scan would need to be defined both in the context of a control template and as a candidate template [FIG. 4, 3]. FIG. 4, 3 shows a simplified example where a 15 second period has been divided into 15, one second intervals denoted by blanks. Interspersed within the blanks, in order, are indicators of the fingertips identified in FIG. 4, 2, and the ENTER command.

In practice, a 15 second period might be conceivably be divided into 0.5 or 0.25 second or smaller intervals. The spacing in time of the fingertips identified in FIG. 4, 2, and the ENTER command can be recorded in a time key vector [FIG. 4, 4]. The time key vector, and the ordered fingerprint image data are part of the overall system authentication template.

FIG. 5 shows a more practical version of the authentication template. In practice, an individual seeking authentication would typically not be able to duplicate the timing characteristics of the successive fingertip scanning operations perfectly. FIG. 5 can be interpreted as a time line with time windows placed on it in accordance with the time key vector presented in FIG. 4, 4. In FIG. 5, a one second window is provided for each fingertip scanning process to be initiated. No such window is implied for the first fingertip scan because by definition the clock count would be zero. Using an absolute time matching requirement, the person seeking authentication would have to submit the correct fingertips for scanning within plus or minus 0.5 seconds of the nominal value, in order to authenticate perfectly relative to our example. Alternatively, if the system designers wanted to make the system independent of cumulative error, they could require that the delay intervals between successive fingertip scans are correct to within plus or minus 1 second, in accordance to our example.

FIG. 6 shows a potential format for the authentication data packet formed in the FIFO buffer of the sensing station and transmitted (with appropriate network communication encapsulation), to the authentication server. One can see the simple structure involving the ordered layering of fingerprint data separated by timing data and perhaps, sensor ID information. The packet data is terminated by the timing data associated with the ENTER pushbutton or send command. The structure of the authentication data packet is not critical as long as all required data is present and the sensing stations and authentication server are consistent. The packet structure shown in the figure is recommended because it is consistent with the example of the detailed description of operation presented here and the function of FIFO buffers.

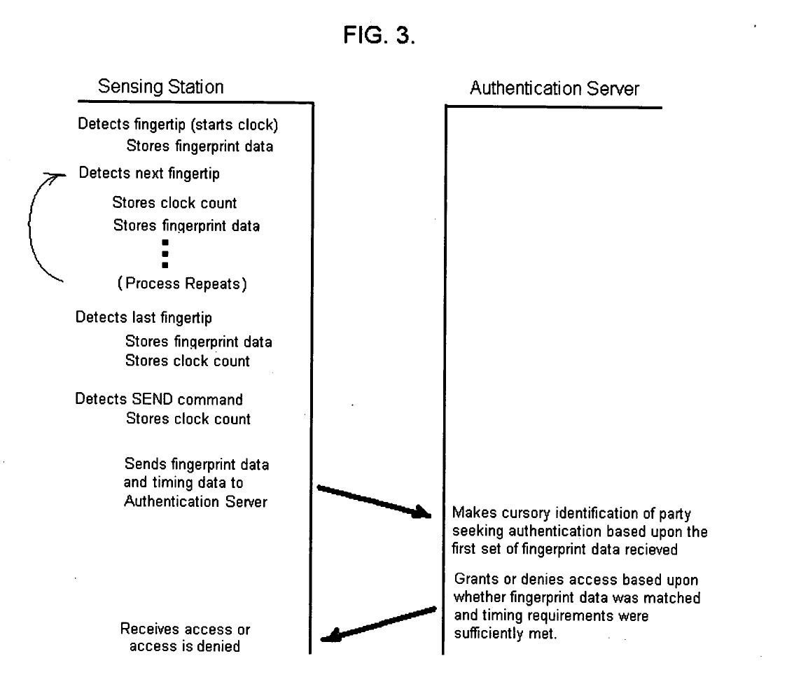

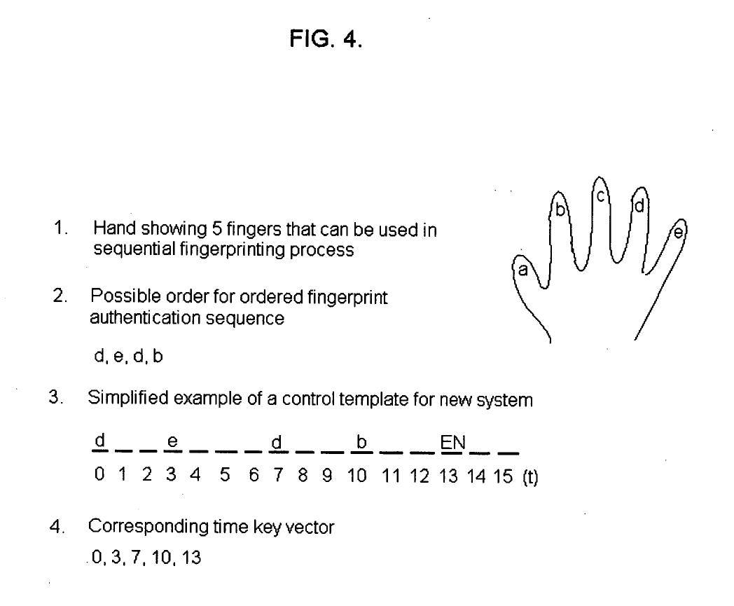

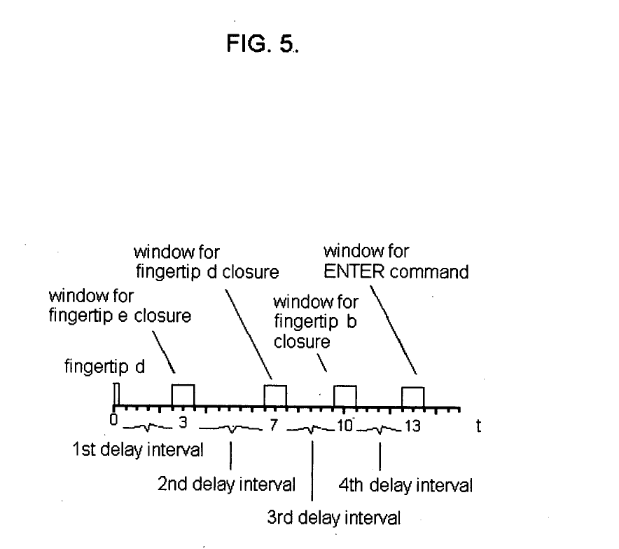

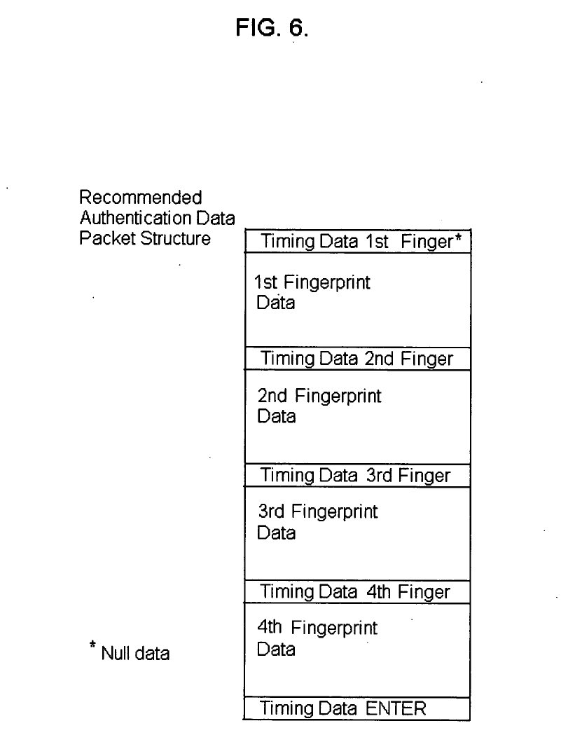

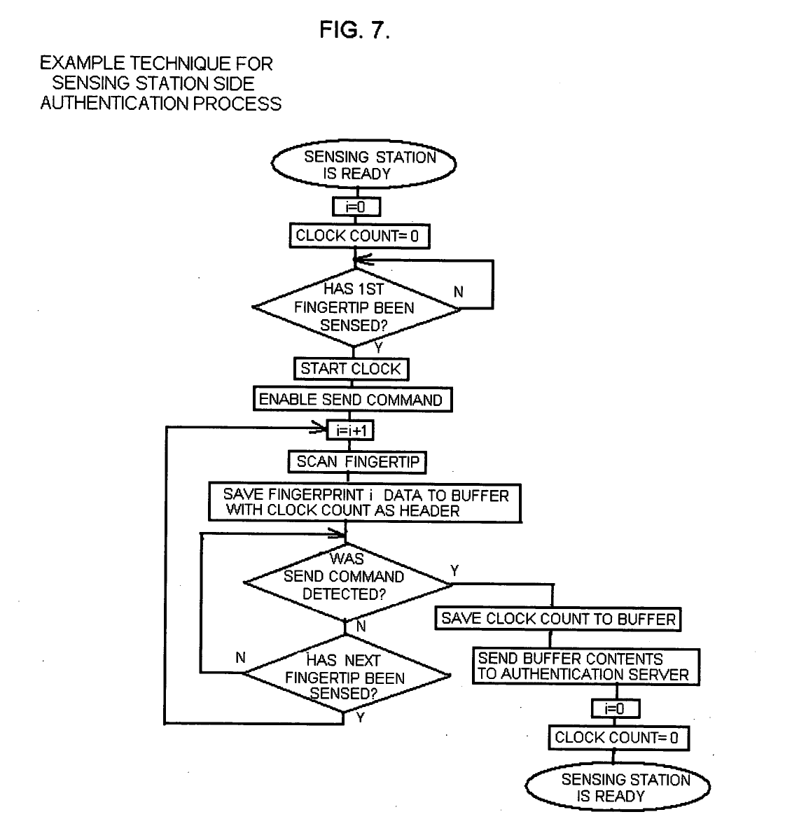

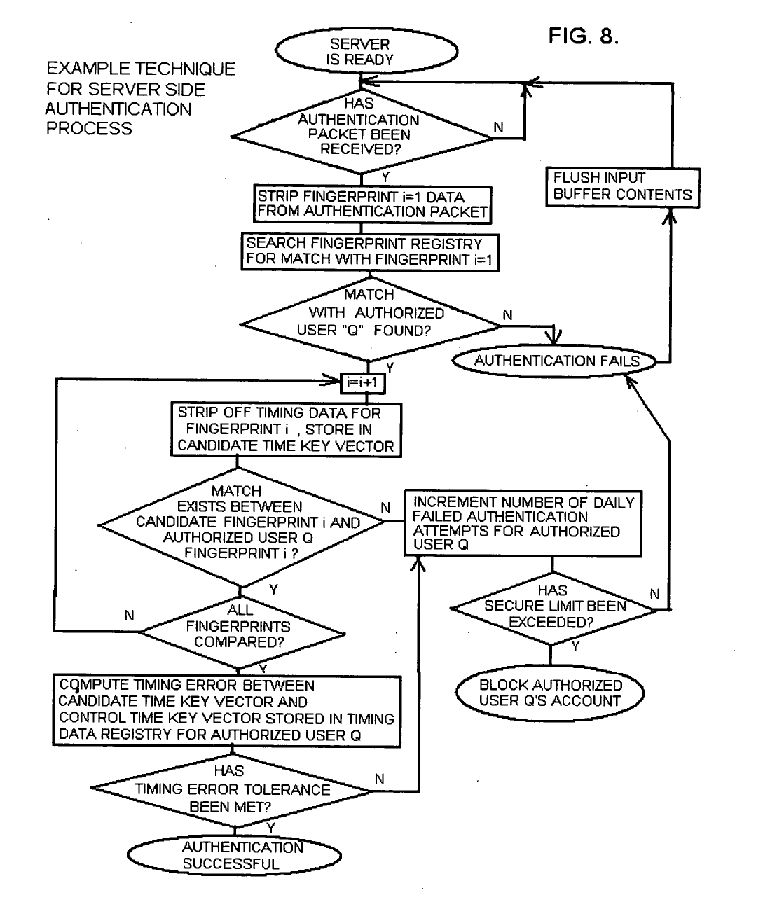

FIGS. 7 and 8 breakdown the process set forth in the detailed description and in FIG. 3 more succinctly and in a manner more conducive to computer or hardware implementation. FIG. 7 is a flowchart which is intended to capture the basic scanning station side functionality of the recommended system implementation. The example taught here is just one of many possible configurations which could by implemented by any person skilled in the art, that could accomplish the task of carrying out ultra-secure fingerprint authentication based upon an ordered sequence of fingerprints which may be timed, and associated with a plurality of fingertip sensors. The claim includes any circuit or algorithm, or combination thereof, which emulates the techniques described herein regardless of the fingerprint sensor technology, timing detection method, communication method, and candidate-control correlation method employed. Most of the functionality of the recommended implementation has already been described in the discussion of FIG. 3 on pages 11 and 12. The following is a discussion intended to aid in the correct interpretation of the flowcharts.

The oval at the top of FIG. 7 is representative of the state where the various internal counters and interim values have been initialized. The integer variable “i” is a pointer to which fingertip of the overall authentication sequence is being scanned and timed. Authentication is not possible until at least one fingerprint has been scanned so the send command is not enabled until after a fingertip has been sensed. This reduces the amount of accidental traffic to the authentication server. The first conditional diamond is associated with a logical loop that is in process until the first fingertip is sensed on the sensing pad. After the first fingertip is sensed, the clock is started, the pointer “i” is incremented and the fingerprint is scanned. The associated data is saved to the FIFO buffer local to the scanning station. The clock count at this point is immaterial at this point and may or may not be included as a header. Only subsequent timing data is meaningful to the authentication decision. At this point in the process the scanning station must be interrogating the ENTER key in order to check for a send command. If a send command is found, the clock count is saved to the buffer and the buffer contents are transmitted to the authentication server. The scanning station can be reinitialized at that point, or reinitialization can take place after the response from the authentication server is received. If the send command was not detected, the scanning station remains in a quiescent state defined by the two lower conditional diamonds and the logical loop. When the next fingertip is sensed, the clock count will be saved to the FIFO buffer, “i” will be incremented and the “i-th” fingertip will be scanned and saved to the FIFO buffer with the timing data provided as a header. The quiescent state of waiting for a send command or another fingertip is re-entered. If a fingertip is detected, the fingertip is scanned and saved to the buffer with the new timing data as a header. If the send command is detected the clock count is saved to the buffer and the buffer contents are transmitted to the authentication server.

The oval at the top of FIG. 8, with the first conditional diamond, represents a quiescent state where the authentication server is waiting to receive and authentication packet to adjudicate. When an authentication packet is received, the first fingerprint which was entered by the party seeking authentication is stripped off from the packet and a match is sought between it and every “first fingerprint” data set maintained in the fingerprint registry. In effect, this first fingerprint acts as a primary key to the remaining fingerprint data making up the rest of the authentication template. There is no requirement that the first fingerprint be used as the key to the fingerprint data registry. It is used in our example for the sake of simplicity.

If a match is not found in the fingerprint data registry, then authentication is considered failed and the server can return a “failed authentication” message to the fingerprint sensing station and clear the contents of it's own input buffer before returning to its quiescent state. If a match is found, we will assume that the match was made with the first fingerprint in the profile of authorized user “Q”. Consistent with the diagram of the data structure for the authentication packet shown in FIG. 6, the timing data associated with the second fingerprint can be stripped off and stored in the candidate time key vector. This timing data may also include sensor choice data if sensing stations with plurality sensors are used. The sensor choice data could be stripped off with the timing data, separated, and stored in a candidate sensor choice map, which can be compared with the authentication profile data, that could be maintained in a separate sensor choice registry, identified with user Q. The data for the second fingerprint provided by the party seeking authentication is compared with the second fingerprint of authorized user Q's authentication profile. If the data fail to match, the number of consecutive failed attempts to authenticate on authorized user Q's account is incremented by one. This is done so a block can be put on authorized user Q's account should a potential intruder attempt many guesses at user Q's fingerprint order, timing characteristics, or sensor choice. After the authentication failure is logged for user Q's account, and a decision on whether to block the account is made, the authentication failure process described earlier on page 12 is engaged and the server returns to it's quiescent state. If the second set of fingerprint data did match, and there are more candidate-profile fingerprint data sets to compare, then the next set of timing data is stripped off, saved to the time key vector, and the fingerprint data is compared, in repetition of the process described earlier. When the case where no more fingerprint pairs are to matched arises, the timing error between the candidate authentication and the authentication profile for user Q is computed and compared against the maximum allowable error. Also, within this conditional diamond, one can consider that the choice of sensors submitted by the authenticating party is being compared against that established in the profile for user Q. Authentication succeeds or fails based upon the results of these remaining comparisons and access is either granted or denied, and the appropriate signal is returned to the sensing station. The authentication server reinitializes and returns to it's quiescent state.

Literature Cited

1. Underhill, Sandra. 2001. “Fingerprint Identification Recognition Devices. ” InfiniSource. Internet document [cited 1 Jan. 2002]. URL: www.infinisource.com.
2. ThinkQuest. “Biometrics—The Hand—The Fingerprint”. ThinkQuest. Internet document [cited 1 Jan. 2002]. URL: http://library.thinkguest.org/28062/hand/finger.html.
3. ID Systems. “Security Systems—Fingerprint Identification.” ID Systems, Q&A. Internet document [cited 1 Jan. 2002]. URL: http://www.ausmedia.com.au/precise.htm.

1.) A system for fingerprint scanning having a plurality of functions comprising:
at least one fingerprint scanning sensor;
a clock;
a data storage buffer;
a communication port, whereby digitized sequences made up of scanned and stored fingerprint data can be conveyed, with or without timing data associated with sequential fingerprint scanning processes, to an authentication server.

2.) A device which is capable of scanning and storing a plurality of fingerprint data and conveying said data across a communication medium.

3.) The device according to claim 2 which can include tiring data corresponding to the actions of the party seeking authentication during the successive fingerprint scanning processes with said fingerprint data.

4.) The device according to claim 2 which can include fingerprint scanning sensor selection data corresponding to the fingerprint scanning sensor choices of the party seeking authentication during the successive fingerprint scanning processes with said fingerprint data.

5.) A device by which fingerprint authentication can be performed based upon adequate matching of a set of one or more fingerprint images or data with a known valid set.

6.) A device according to claim 5 by which authentication can be performed based upon the submitted order of said fingerprint images or data.

7.) A device according to claim 5 by which authentication can be performed based upon timing associated with the successive fingerprint scanning processes.

8.) A device according to claim 5 by which authentication can be based upon the fingerprint scanning sensors chosen by the party seeking authentication during the successive fingerprint scanning processes.

9.) A process which allows for fingerprint authentication through a multiplicity of fingerprint data or images for each authenticating party.

10.) A process according to claim 9 which relies on the correct ordering of said fingerprint data or images for authentication purposes.

11.) A process according to claim 9 which relies on the correct choice of fingerprint sensors for authentication purposes.

12.) A process according to claim 9 and claim 10 which relies on timing data imparted by the authenticating party to the device.

13.) A process according to claim 9 and claim 10 which relies on timing data derived from the authenticating party by means of the fingerprint scanning process.

14.) Claim includes any circuit or algorithm or combination thereof, which emulates the techniques described herein regardless of the fingerprint sensor technology, timing detection method, communication method, and candidate-control correlation method employed.
